(19) United States
(12) Patent Application Publication
(10) Pub. No.: US 2021/0097529 A1
(43) Pub. Date: Apr. 1, 2021

(54) SYSTEMS AND METHODS FOR USE IN IMPLEMENTING FIXED CURRENCY CONVERSION IN NETWORK TRAFFIC

(71) Applicant: MASTERCARD INTERNATIONAL INCORPORATED, Purchase, NY (US)

(72) Inventors: Daniel Brian O'Sullivan, White Plains, NY (US); Theodore Michael Black, Northport, NY (US)

(21) Appl. No.: 16/589,510

(22) Filed: Oct. 1, 2019

(51) Int. Cl. G06Q 20/38; G06Q 20/02; G06Q 20/40; G06Q 20/14; G06Q 20/20; G06Q 20/10

(52) U.S. Cl. CPC G06Q 20/381; G06Q 20/023; G06Q 20/1085; G06Q 20/14; G06Q 20/20; G06Q 20/40

(57) ABSTRACT

Systems and methods are provided for setting a fixed currency conversion rate for a transaction, as determined during authorization of the transaction. One exemplary method includes receiving a clearing file for the transaction, where the clearing file includes a clearing transaction amount based on a final transaction amount for the transaction and a clearing currency conversion rate. The method also includes determining a billing transaction amount for the transaction based on the final transaction amount and the fixed currency conversion rate, and appending the billing transaction amount to the clearing file so that a user associated with an account used in the transaction is billed based on the fixed currency conversion rate instead of the clearing currency conversion rate. The method then also includes reconciling a difference between the billing transaction amount and the clearing transaction amount with the issuer as part of settlement of funds for the transaction.

### FIELD

The present disclosure generally relates to systems and methods for use in facilitating fixed currency conversion rates, for users, in network traffic.

### BACKGROUND

This section provides background information related to the present disclosure which is not necessarily prior art.

Users (e.g., cardholders, consumers, etc.) are known to purchase various different products (e.g., goods and services, etc.) from merchants via payment account transactions, and to withdraw cash from banks or at automated teller machines (ATMs) through the use of payment accounts. The users are also known to reside in regions, whereupon a portion of such transactions performed by the users takes place in the regions of their residence, i.e., their native or home regions (using their native currencies). In addition, the users may travel to other regions, i.e., foreign regions, or the users may initiate transactions electronically (from their home regions) with merchants in such other regions (e.g., through online cross-border shopping, etc.), whereupon payment account transactions in the foreign regions may involve different currencies (e.g., foreign currencies, etc.). When performing payment account transactions in foreign regions, each of the transactions is often submitted (for authorization, clearing, settlement, etc.) in the currency of the region in which the merchant or ATM involved in the transaction is located and is subject to a currency conversion to the native currency of the account associated with the user performing the transaction (e.g., Euros to U.S. dollars when the merchant is located in France and the user resides in the U.S., etc.). The rate at which the currency conversion is estimated during authorization may or may not be the same as the rate at which the currency conversion is actually performed during clearing.

Alternatively, when performing such payment account transactions in foreign regions, merchants and ATM providers may offer dynamic currency conversion, or DCC options, whereby users are provided fixed conversion rates at the time of service, as the transactions are converted and submitted in the users' native currencies. Or, in connection with ecommerce transactions (or, potentially, point-of-sale transactions), the foreign merchants may offer multi-currency pricing (MCP) options to the users when performing the transactions, whereby the ecommerce merchants set the pricing for their products in different currencies and the users then shop at the merchants for the products in their desired currencies (e.g., their native currencies, etc.). Again, in this later example, fixed conversion rates are provided to the users by the merchants at the time of service.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in setting a fixed currency conversion rate for a transaction at a time of purchase;

FIG. 2 is a block diagram of a computing device that may be used in the exemplary system of FIG. 1; and

FIG. 3 is an exemplary method that may be implemented in the system of FIG. 1 for setting a fixed currency conversion rate for a transaction at a time of purchase.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Users interact with merchants and ATMs in foreign regions, in which foreign currencies apply to the transactions. Currency conversions are often employed by payment networks involved in the transactions, or by issuers of the payment accounts used in the transactions. The rates at which the conversions are performed (i.e., the currency conversion rates) may be different at the time of authorization of the transactions than at the time of clearing the transactions, whereby the amounts of the transactions (including the currency conversion charges) may change between authorization and clearing. Additionally, DCC options may be offered to the users at the merchants or ATMs, where the users may select the transactions to proceed in their native currencies, as a matter of familiarity, often agreeing to currency conversion rates that may be much higher than the currency conversion rates offered by the payment networks and/or the issuers of the users' payment accounts. Or, the foreign merchants may offer MCP options for their products, in which the pricing is set for the products in different currencies and the users then shop at the merchants for the products in their desired currencies (e.g., their native currencies, in other selected currencies, etc.). As can be appreciated, though, while the MCP options may also account for conversion rates, they again may be much higher than the rates offered by the payment networks and/or the issuers of the users' payment accounts (potentially masked by the underlying prices of the given products).

Uniquely, the systems and methods herein provide for fixed currency conversion rates, for users, whereby in transactions requiring currency conversion the currency conversion rates are set for the users during authorization of the transactions in order to provide certainty to the users of the actual cost of the transactions. In particular herein, a currency conversion rate for a transaction is fixed for a user initiating the transaction, at the currency conversion rate at the time of authorizing the transaction (and, in some implementations, plus an additional share or value added thereto to account for any potential changes in the conversion rate between the time of authorization of the transaction and the time of clearing the transaction, etc.). The transaction is then authorized based on the fixed currency conversion rate (determined at the time of authorization). Later, during clearing (e.g., of the authorized transaction, etc.), the transaction proceeds based on a final current currency conversion rate (as determined at the time of clearing). However, as provided for herein, the payment network (other entity apart from the payment network but still associated with the given service, such as a fee manager, etc.) ensures that the user is billed for the transaction amount multiplied by the fixed currency conversion rate at the time of authorization, while reconciling any difference between the converted transaction amount (based on the fixed currency conversion rate at the time of authorization) and a subsequent transaction amount (based on the final currency conversion rate at the time of clearing) with an issuer of the user's payment account. The reconciliation may involve a debit from or a credit to the issuer for the difference in the two transaction amounts (and more particularly, for the difference in the conversion rates applied at authorization versus clearing). In this manner, the currency conversion rate is generally fixed for the user between authorization and clearing, with the payment network (or other entity) then subsequently coordinating credit/debit, with the issuer of the user's account, to account for any variations/changes in the currency conversion rate between authorization and clearing of the transaction.

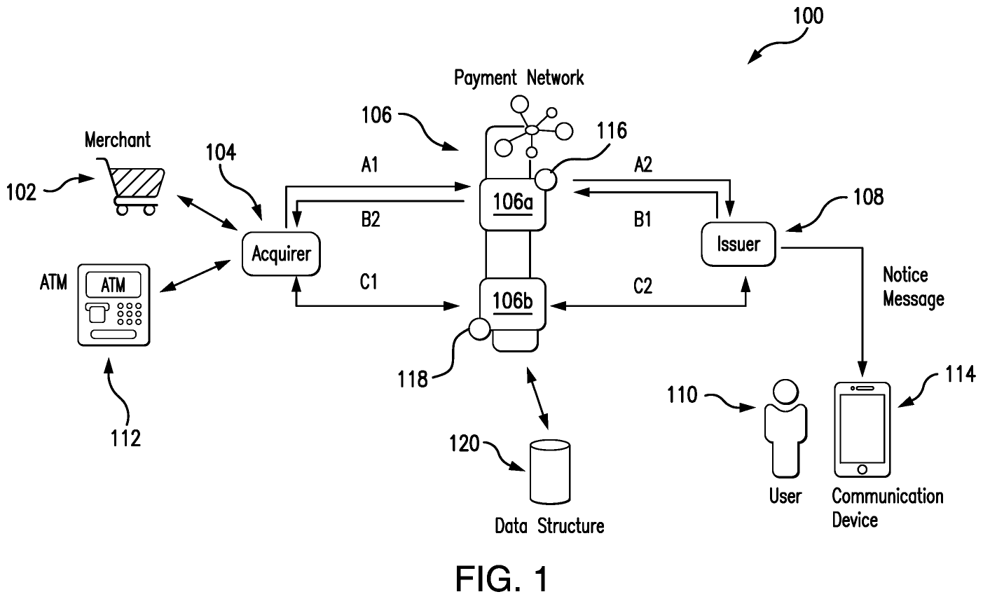

FIG. 1 illustrates an exemplary system 100 in which one or more aspects of the present disclosure may be implemented. Although the system 100 is presented in one arrangement, other embodiments may include systems arranged otherwise depending, for example, on processing of currency conversions, authorization and clearing processes for transactions, etc.

In the illustrated embodiment, the system 100 generally includes a merchant 102, an acquirer 104 associated with the merchant 102, a payment network 106, and an issuer 108 associated with a payment account provided to user 110, each of which is coupled to (and is in communication with) one or more networks. Each of the one or more networks is indicated by arrowed lines in FIG. 1, and each may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. As an example, one of the networks may include multiple different networks, such as a private payment transaction network made accessible by the payment network 106 to the acquirer 104 and the issuer 108 and, separately, the public Internet, which is accessible as desired to the merchant 102, the issuer 108, an ATM 112, and a communication device 114 associated with the user 110, etc.

The merchant 102 in the system 100 is generally associated with products (e.g., goods and/or services, etc.) offered for sale to consumers and which may be purchased, as desired, by the consumers (including the user 110 acting as a consumer). The merchant 102 may offer the products for sale and sell the products through a physical storefront (i.e., a brick-and-mortar location), or through one or more mobile locations, websites, etc. In the illustrated embodiment, the merchant 102 is located in a foreign region, as compared to a native region of the user 110. The system 100 further includes the ATM 112, which is also associated with the acquirer 104 and is configured to permit the user 110 to initiate account transactions to withdraw money from the payment account issued by the issuer 108. In connection therewith, the ATM 112 is configured to initiate a transaction by seeking authorization for the transaction from the issuer 108 much like a point-of-sale (POS) terminal at the merchant 102. Further, the ATM 112 is also coupled to (and/or is in communication with) the acquirer 104 and/or the payment network 106, for example, through one or more networks, as illustrated by the arrowed lines in FIG. 1 (and as generally described above).

In the illustrated embodiment, the acquirer 104 generally includes a banking institution or other financial institution, which has issued an account to the merchant 102, whereby funds associated with payment account transactions to the merchant 102 are delivered. That said, it should be appreciated that the acquirer 104 may include an entity other than a banking or financial institution (e.g., a payment facilitator with a money service business license, etc. that issues merchant accounts and conducts settlement funding to the sub-merchants; etc.). The issuer 108 includes a banking institution or other financial institution, which has issued the payment account to the user 110, and through which the user 110 is permitted to fund transactions with the merchant 102 and other merchants, and the ATM 112, etc. The payment account may include, for example, a credit account, a debit account (e.g., a checking account or savings account, etc.), or a prepaid account, etc.

Further, in this exemplary embodiment, the payment network 106 includes an authorization network 106a (e.g., BankNet from Mastercard®, etc.) and a separate clearing system 106b (e.g., the global clearing management system (GCMS) from Mastercard®, etc.) as shown in FIG. 1 (as part of a dual message system). The authorization network 106a is configured to coordinate authorization of transactions, whereby the issuer 108, for example, provides approval for a transaction to proceed (when payment accounts issued by the issuer 108 are involved in the transactions), or declines a transaction. The clearing system 106b, on the other hand, is configured to coordinate clearing and settlement of approved transactions, whereby the relative financial positions (i.e., “due to the network” and “due from the network”) of different banking institutions, including the acquirer 104 and the issuer 108, are determined and funds are transferred consistent with the relative positions. With that said, in various other embodiments, the payment network 106 may include a single message system, which employs a single message scheme, whereby a single message may be used for both authorization, clearing and settlement.

The communication device 114 associated with the user 110 is configured to access, and allow the user 110 to view, one or more details of his/her payment account, as issued by the issuer 108 (e.g., balances, transactions, etc.), and to send and/or receive messaging to and/or from the issuer 108. In connection therewith, the communication device 114 includes a network-based application (not shown) associated with and/or provided by the issuer 108, which configures the communication device 114 to operate as described herein. The communication device 114 may include, for example, a smartphone, tablet, laptop, or other portable computing device (or other computing device), etc. That said, it should be appreciated that in various embodiments of the present disclosure, use of the communication device 114 may not be required.

While only one merchant 102, one acquirer 104, one payment network 106, one issuer 108, one user 110, one ATM 112, and one communication device 114 are illustrated as included in the system 100 of FIG. 1, it should be appreciated that any number of these entities and/or persons (and their associated components) may be included in the system 100, or may be included as a part of systems in other embodiments, consistent with the present disclosure.

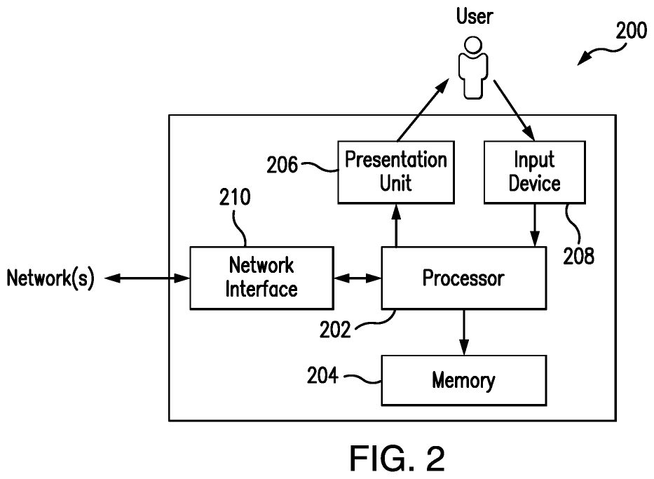

FIG. 2 illustrates an exemplary computing device 200 that can be used in the system 100. The computing device 200 may include, for example, one or more servers, workstations, personal computers, laptops, tablets, smartphones, POS devices, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the acquirer 104, the payment network 106 (and its components), and the issuer 108, may include, or may be implemented in, a computing device such as the computing device 200. In addition, the merchant 102 (or more specifically, a POS terminal at the merchant 102) and the ATM 112 may each be considered a computing device consistent with the computing device 200. Further, the communication device 114 associated with the user 110 may be considered a computing device consistent with the computing device 200. That said, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data (e.g., amounts of transactions, authorization identifiers (e.g., as designated authorization IDs, etc.) for transactions, rates (e.g., currency conversion rates (CCRs), etc.), transaction currencies, cardholder billing currencies, currency codes, primary account numbers (PANs), issuer identifiers, etc.), conversion rates, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein (e.g., one or more of the operations of method 300, etc.) and thereby cause the processor 202 to operate in a unique and specific manner, for example, to achieve the practical application(s) associated with the performance of such operations. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., conversion rate options, etc.), either visually or audibly, to a user of the computing device 200, for example, the user 110, users associated with other parts of the system 100, etc. Various interfaces may also be displayed at computing device 200, and in particular at presentation unit 206, to display such information. The presentation unit 206 may include, without limitation, a presentation unit such as a liquid crystal display (LCD), a light-emitting diode (LED) display, an organic LED (OLED) display, an “electronic ink” display; speakers; another computer; etc. In some embodiments, the presentation unit 206 may include multiple devices.

The computing device 200 also includes an input device 208 that receives inputs from the user of the computing device 200 (i.e., user inputs). The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks (e.g., as indicated by the arrowed lines in FIG. 1, etc.). Further, in some exemplary embodiments, the computing device 200 may include the processor 202 and one or more network interfaces (including the network interface 210) incorporated into or with the processor 202.

Referring again to FIG. 1, the system 100 includes a fee manager 116 in communication with the authorization network 106a and a fee manager 118 associated with the clearing system 106b (e.g., where the fee managers 116 and 118 are configured to process outputs from the authorization network 106a and the clearing system 106b, respectively, and communicate them to the issuer 108 and/or the user 110 as appropriate, etc.). The fee managers 116 and 118 are generally separate from the authorization network 106a and the clearing system 106b, respectively, in the system 100 (e.g., as separate entities, etc.), but are in communication therewith. With that said, it should be appreciated that the fee managers 116 and 118 may be included or incorporated in the respective authorization network 106a and/or clearing system 106b (e.g., the fee managers 116 and/or 118 could be part of the payment network 106, etc.), or the fee managers 116 and/or 118 may be included or incorporated in another part of the system 100 in other embodiments (e.g., in the issuer 108, etc.). In addition, while two fee managers 116 and 118 are illustrated in FIG. 1, it should be appreciated that the fee managers 116 and 118 may be consolidated into a single fee manager in other embodiments (where the single fee manager then interacts with the authorization network 106a and the clearing system 106b of the payment network 106).

The system 100 also includes a data structure 120 coupled in communication with the payment network 106 (including the authorization network 106a and clearing system 106b) and/or in communication with the fee managers 116 and 118 to allow access for storing and/or retrieving data as needed (and as described herein).

The fee managers 116 and 118 are configured, by executable instructions, to perform one or more of the operations described herein, for example, relating to conversion of currencies and communication with the issuer 108 and/or the user 110, etc. In connection therewith, the fee managers 116 and 118 and the data structure 120 may each (separately or together) be considered a computing device consistent with computing device 200. In addition, while the data structure 120 is illustrated as separate from the fee managers 116 and 118 in FIG. 1, in other embodiments the data structure 120 may be included, or integrated, in either of the fee managers 116 and 118, for example, in memory 204 therein, etc.

Generally in the system 100, the payment network 106 (and/or the fee managers 116, 118) and the issuer 108 have agreed to the fixed currency conversion rate service described herein, whereby the issuer 108 has specifically registered for and/or opted into the service (with the payment network 106). As such, when processing transactions, the payment network 106 is configured to identify transactions associated with the issuer 108 based on such registration (e.g., based on the issuer identification number (IIN) for the issuer 108 being associated with the primary account number (PAN) for a payment account used in a transaction and included in an authorization request for the transaction, etc.), and transactions associated with other issuers that have opted into the fixed currency conversion service.

With that said, when the user 110 initiates a transaction at the merchant 102 or the ATM 112, and declines DCC (and, potentially, when MCP is available, elects to proceed in the foreign currency of the merchant 102 instead of the user's native currency or in another currency different from the user's native currency), an authorization request (including an authorization ID for the transaction) (broadly, an authorization message) is compiled by the merchant 102 or the ATM 112 and provided to the acquirer 104 (via a network connection therebetween). The authorization request includes the original transaction amount in the local, foreign currency of the merchant 102 (or the selected currency in the case of MCP) along with other information regarding the transaction such as, for example, an indication of the merchant 102 or the ATM 112 (e.g., a merchant category code (MCC) therefor, etc.) and an indication of the user's payment account (e.g., a PAN, other payment account credentials for the payment account, etc.), etc. In turn, the acquirer 104 is configured to transmit the authorization request to the payment network 106 (as indicated at A1 in FIG. 1).

In response, the authorization network 106a of the payment network 106 (or, potentially, the fee manager 116 when, for example, the fee manager is separate from the authorization network 106a) is configured to identify the authorization request as requiring a currency conversion (e.g., based on a difference in a cardholder billing currency (or a code therefore) included in the authorization request and a transaction currency (or a code therefore), or based on the difference between an issuer settlement currency (or a code therefore) included in the authorization request and a transaction currency (or a code therefore)), etc. And, when such currency conversion is required (when determined by the authorization network 106a), the authorization network 106a is configured to pass the transaction to the fee manager 116.

In turn, the fee manager 116 is configured to determine a current currency conversion rate for the transaction (i.e., the currency conversion rate at the time of the transaction, or the currency conversion rate at the date of authorization, etc.), for converting the original transaction amount from the local, foreign currency of the merchant 102 to the native currency of the user's payment account. In addition, the fee manager 116 is also configured to increase the determined currency conversion rate by an additional share or value (or cushion) to account for any potential changes (specifically, any increases) in the conversion rate between the time of authorization of the transaction and the time of clearing the transaction. The share may include a fixed value or a variable value, potentially, depending on the type of transaction and/or the merchant 102/ATM 112 involved in the transaction (e.g., by MCC in the authorization request, etc.), or it may be based on historical changes to the currency conversion rate, the type of currencies involved, time of day/time of week, market volatility, etc. In any case, the fee manager 116 is then configured to convert the original transaction amount to the authorization transaction amount (in the native currency of the user's payment account), based on the identified current currency conversion rate at authorization (plus the added share or cushion) (broadly, a fixed authorization currency conversion rate), and to include the authorization transaction amount in the authorization request (or, alternatively, to transmit the authorization transaction amount to the authorization network 106a where the authorization network 106a then includes the authorization amount in the authorization request). It should be appreciated that the fee manager 116 may also be configured to add one or more fees to the authorization transaction amount, as necessary (e.g., cross-border fees imposed by the issuer 108 (e.g., 2-3%, etc.), etc.).

The fee manager 116 and/or the authorization network 106a may further be configured to store the determined currency conversion rate at authorization (i.e., the current currency conversion rate at authorization plus the added share) (or, the fixed authorization currency conversion rate) for the transaction, as well as the authorization transaction amount, in the data structure 120 (e.g., in association with an authorization ID for the transaction, in association with one or more other characteristics of the transaction, etc.). In this manner, the determined currency conversion rate at authorization is available to the fee manager 118, for example, for use in subsequently billing and settling with the cardholder (e.g., user 110, etc.) for the transaction at the same rate (such that the determined currency conversion rate at authorization is generally fixed for the user 110 in the system 100 for the given transaction).

The fee manager 116 and/or the payment network 106 (i.e., the authorization network 106a) are/is then configured to pass the authorization request (as modified to include the converted authorization transaction amount and/or as modified to include the determined currency conversion rate at authorization (plus the added share)) on to the issuer 108 (as indicated at A2 in FIG. 1).

Then in the system 100, upon receipt of the authorization request, the issuer 108 evaluates the transaction (e.g., in a conventional manner taking into account factors such as a status of the user's account, funds available in the user's account, fraud scoring for the transaction, etc.) and, in turn, is configured to compile an authorization reply, in response to the authorization request, wherein the issuer 108 either approves or declines the transaction. And, the issuer 108 then transmits the authorization reply to the payment network 106 (and, in particular, to the authorization network 106a) (as indicated at B1 in FIG. 1). In addition, the issuer 108 may be configured to transmit a notice message to the user 110 at the communication device 114 (e.g., via an application installed thereon, via an SMS text message, via an email, etc.), which includes the authorization transaction amount and/or the determined currency conversion rate at the time of authorization for the transaction. In several embodiments, the notice message may instead be transmitted to the merchant 102 and/or the ATM 112 at which the transaction originated (rather than the communication device 114) consistent with an authorization message format (e.g., consistent with the ISO 8583 standard for the authorization request and authorization reply, etc.), whereby the merchant 102 and/or the ATM 112 may be configured to then display the determined currency conversion rate and/or the authorization transaction amount (as converted using the currency conversion rate at authorization plus the added share) to the user 110. As still a further alternative, the issuer 108 may communicate such information to the user 110 in a more conventional manner, such as an entry to the user's account statement, etc.

In response to receiving the authorization reply from the issuer 108, the authorization network 106a (and/or the payment network 106) is/are configured to transmit the authorization reply to the acquirer 104 (as indicated at B2 in FIG. 1), which in turn, is configured to provide (or forward) the authorization reply to the merchant 102 or the ATM 112 (whichever initiated the transaction). When the transaction is approved by the issuer 108 (in the authorization reply), the acquirer 104 and the issuer 108 are configured to store the transaction to a transaction log (e.g., in corresponding memory 204 thereof, etc.).

Further, at some time after the transaction is authorized (e.g., that same day, the next day, or on a later date, etc.), the acquirer 104 is configured to submit the transaction to the payment network 106 for clearing and settlement (e.g., to the clearing system 106b of the payment network 106, etc.), for example, in the form of a clearing file or record (including various details of the transaction such as the original transaction amount (or final transaction amount, depending on the type of merchant), an authorization ID, a date and time of the transaction and/or corresponding authorization request, etc.), as part of a batch file (as shown at C1 in FIG. 1) with various other transactions authorized through the payment network 106.

As part of the clearing process, then (e.g., upon receipt of a batch file from the acquirer 104 for authorized transactions, etc.), the clearing system 106b is configured to identify the example transaction (from the clearing record for the transaction in the batch file) as requiring currency conversion (e.g., again based on a difference in a cardholder billing currency (or a code therefore) included in the clearing file and a transaction currency (or a code therefore), or based on the difference between an issuer settlement currency (or a code therefore) included in the clearing file and a transaction currency (or a code therefore)), etc. And, when currency conversion is required, the clearing system 106b is configured to convert the original transaction amount for the transaction to a clearing transaction amount (in the native currency of the user's payment account), based on the identified currency conversion rate at clearing (i.e., the current currency conversion rate), and to include the clearing transaction amount in the clearing record for the transaction.

Also in the system 100, as part of ensuring that the user 110 is billed based on the currency conversion rate fixed at authorization of the transaction (including the added share, but not at the currency conversion rate at clearing), the fee manager 118 is configured to intercept the clearing record for the transaction from the clearing system 106b (e.g., based on the determination that currency conversion is required, based on an authorization ID for the transaction, etc.) and replace the clearing transaction amount in the clearing record with an amount in the user's billing currency based on the currency conversion rate fixed at authorization (including the added share). It should be appreciated that, while the currency conversion rate enjoyed by the user 110 is fixed between authorization and clearing, the actual final transaction amount is not, as the final amount submitted for clearing in the merchant's currency is not always fixed. For example, a hotel may authorize a cardholder's account for incidentals but may request payment on a smaller (or larger) amount. The final amount (known at the time of clearing) is converted from the merchant's currency into the cardholder's billing currency using the currency conversion rate fixed at authorization (including the added share). That said, the fee manager 118 is configured to look up, in the data structure 120, the currency conversion rate for the transaction used at authorization (e.g., by the authorization ID of the given clearing record in the batch file, date and time of the transaction and/or corresponding authorization request, etc.). The fee manager 118 is then configured to calculate the authorization transaction amount for the transaction based on the transaction amount as finally billed to the user 110 and the currency conversion rate for the transaction used at authorization (including the added share) and replace (e.g., overwrite, etc.) the clearing transaction amount for the transaction in the clearing record with the final transaction amount so converted. And, in turn, the fee manager 118 is configured to direct the clearing record, as modified, to the issuer 108, for example (as shown at C2 in FIG. 1).

It should be appreciated that, while the fee manager 118 is employed to ensure that the authorization currency conversion rate is used in cardholder billing at the time of clearing, the clearing system 106b may be similarly configured to do the same in other embodiments. In particular, the clearing system 106b may be configured, upon identifying the transaction as needing currency conversion, to retrieve the currency conversion rate used at authorization of the transaction (if applicable) and to convert the original transaction amount for the transaction to a final transaction amount (in the native currency of the user's payment account), based on the identified currency conversion rate at authorization. The clearing system 106b then includes this amount as the transaction amount in the clearing record for the transaction (as compared to a transaction amount based on a current currency conversion rate) (and without further relying on the fee manager 118 to do the same, in this exemplary embodiment).

Clearing and settlement of the transaction (vis-à-vis the payment network 106 and the issuer 108) then proceed at the issuer 108 based on the final transaction amount included in the clearing record (i.e., based on the currency conversion rate at the time of clearing). As such, the user 110 is charged based on the authorization currency conversion rate applied to the final transaction amount (as replaced in the clearing record for the transaction by the fee manager 118), but the issuer 108 is charged using the network's currency conversion rate set at clearing (whereby clearing and settlement of the transaction between the payment network 106 and the issuer 108 remains generally conventional, even though the user 110 is billed at the currency conversion rate fixed at authorization). Then, in connection with reconciling the transaction, the fee manager 118 is configured to compare the currency conversion rate for the transaction used at authorization (or calculated transaction amount based on the currency conversion rate at authorization) to the currency conversion rate for the transaction used at clearing (or calculated transaction amount based on the currency conversion rate at clearing). As can be appreciated, these rates (or amounts) may be different due to changes in the currency conversion rates from authorization of a transaction to clearing/settlement of the transaction (particularly where clearing of the transaction takes place multiple days after authorization of the transaction).

Following comparison of the currency conversion rate for the transaction used at authorization and the currency conversion rate for the transaction used at clearing, for example, when the authorization rate is greater than the clearing rate, the fee manager 118 is configured to rectify the difference and charge the issuer 108 the difference. But, when the currency conversion rate for the transaction used at authorization is less than the currency conversion rate for the transaction used at clearing, the fee manager 118 is configured to rectify the difference and credit the issuer 108 the difference. With that said, it should be appreciated that when the currency conversion rate for the transaction used at authorization is the same as the currency conversion rate for the transaction used at clearing, a further rectification may not be required.

It should also be appreciated that when the fixed currency conversion rate service described herein is provided through the payment network 106, such rectification may be effected directly as part of settlement between the payment network 106 and the issuer 108 of the user's account (e.g., consolidated into settlement whereby a single payment may be effected for the transaction and the rectification, etc.). Alternatively, when the fixed currency conversion rate service is provided by an entity apart from the payment network 106 (e.g., by another payment network, by the fee manager(s) 116/118 as a separate entity from the payment network 106, etc.) (e.g., whereby the fixed currency conversion rate service described herein may be considered generally brand agnostic with respect to the payment network 106, etc.), such rectification may be effected separate from settlement of the transaction through the payment network 106 (e.g., the fee manager(s) 116/118 may reconcile separately with the issuer 108 apart from settlement of the transaction between the payment network 106 and the issuer 108, etc.). In this way, the billing process between the issuer 108 and the user 110 for the transaction (as facilitated by the fixed currency conversion rate service described herein) can be separate from (or can proceed independent of) network settlement of the transaction between the payment network 106 and the issuer 108. And, in such examples, network settlement of the transaction can proceed in a generally conventional manner (such that implementation of the fixed currency conversion rate service herein may not even affect or require change to the clearing and settlement service provided by the payment network 106 and may take place without the payment network 106 even being aware).

While directly above the currency conversion rate for the transaction used at authorization and the currency conversion rate for the transaction used at clearing are compared in the above example, it should be appreciated that a similar comparison may be performed by the fee manager 118 based on the authorization transaction amount for the transaction and the clearing transaction amount. The difference in the amounts may then be used to similarly determine appropriate amounts for rectification.

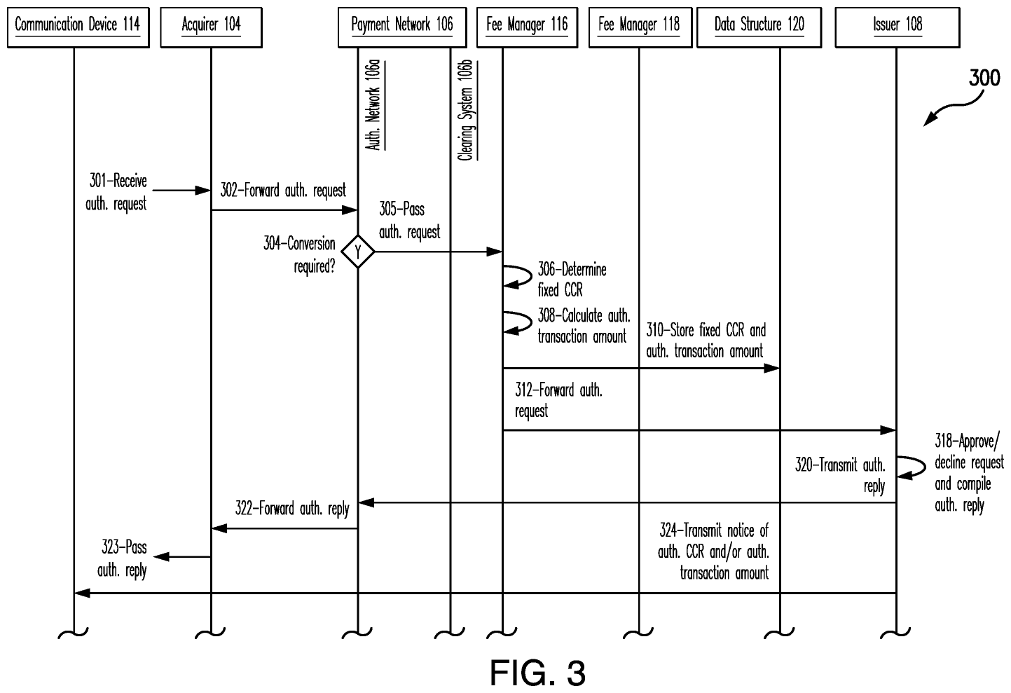

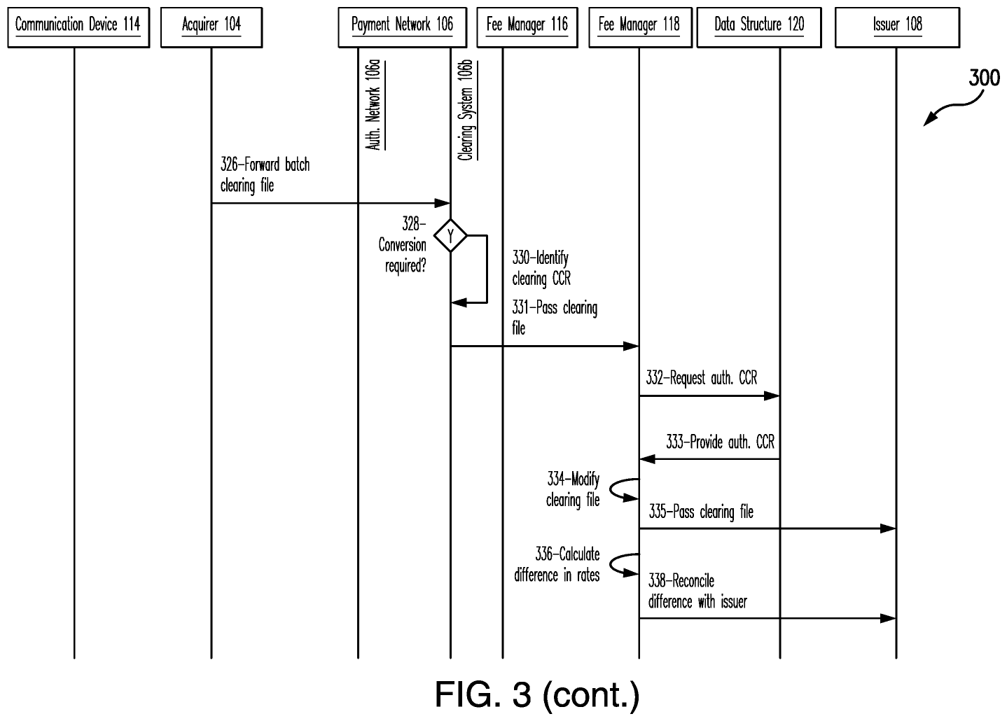

FIG. 3 illustrates an exemplary method 300 for use in setting a fixed currency conversion rate for a transaction for a user at the time of a purchase (e.g., at the time of authorizing the purchase, etc.). The exemplary method 300 is described with reference to the system 100, and in particular to the payment network 106 thereof, etc. Further reference is also made to the computing device 200. However, it should be understood that the methods herein are not limited to the system 100 or the computing device 200, as the method 300, for example, may be implemented, at least in part, in other parts of the system 100 or in other suitable systems, or in multiple other computing devices. Likewise, the systems and the computing devices herein should not be understood to be limited to the exemplary method 300.

At the outset in the exemplary method 300, the user 110 initiates a payment account transaction at the merchant 102 for a product with a cost of £100.00 (where the local currency for the merchant 102 is Great Britain Pounds (GBP), and where the merchant 102 is located in a foreign region (e.g., Country B or Great Britain, etc.) as compared to the native or home region of the payment account (e.g., Country A or the United States, etc.) (and where the user's native or home currency is U.S. Dollars (USD or $)). In connection therewith, the user 110 presents credentials for his/her payment account to the merchant 102, for example, by swiping, contacting, waving, etc., a payment card (or virtual wallet included in the communication device 114), by providing the credentials to the merchant 102 via an ecommerce interface associated with the merchant 102, etc. In response, the merchant 102 compiles an authorization request (broadly, an authorization message) for the transaction and transmits the authorization request to the acquirer 104, where the acquirer 104 then receives the authorization request, at 301. The authorization request may include, for example, a PAN for the user's payment account, a native currency indication (or code) for the user's payment account (i.e., U.S. Dollars), a transaction amount for the transaction in GBP (i.e., £100.00), a currency code for the merchant 102 indicative of GBP, and other suitable data.

In turn, at 302, the acquirer 104 forwards the authorization request to the authorization network 106a (broadly, the payment network 106). In response, the authorization network 106a identifies the transaction as involving a currency other than the user's native currency, whereby it determines that conversion is required, at 304. This may be accomplished by comparing the currency code for the merchant 102 in the authorization request to the currency code of the native currency of the user's payment account (e.g., GBP to U.S. Dollars, etc.). When the transaction requires currency conversion, the authorization network 106a passes, at 305, the authorization request to the fee manager 116, in whole or in part. For example, the authorization network 106a may pass only limited information from the authorization request, including the transaction currency (e.g., GBP, etc.), cardholder billing currency (e.g., U.S. Dollars, etc.), and settlement currency (and a transaction identifier), etc., or it may pass the entire authorization request. When conversion is not required, though, the authorization network 106a may simply forward the authorization request to the issuer 108 in a conventional manner.

In various embodiments herein, the authorization network 106a may pass all authorization requests to the fee manager 116 (or may allow the fee manager 116 access to, or to “see,” all authorization requests). Or, the fee manager 116 may intercept all authorization requests as they are directed by the authorization network 106a to the issuer 108 (whereby the authorization network 106a may then implement any required currency conversion). Then, in such embodiments, the fee manager 116 may determine (or confirm, when the authorization network 106a made a prior determination) whether or not a given transaction requires currency conversion. And, when conversion is not required, the fee manager 116 may then forward the authorization request to the issuer 108 in a conventional manner.

In any of the above embodiments, upon receipt of the authorization request and (potentially) upon a determination (or confirmation) that currency conversion is required, the fee manager 116 identifies, at 306, a current currency conversion rate, at authorization, for the transaction (e.g., a current conversion rate for GBP to U.S. dollars in the above example, etc.) (e.g., 1.3550 USD/GBP, etc.) and, in this example, also increases the identified currency conversion rate by a share (broadly, to form a fixed currency conversion rate for the transaction at the time of authorization) (i.e., a fixed CCR in FIG. 3). The share may be a percentage or an amount which is fixed for all transactions. In connection therewith, the share may be based on historical data, whereby the share is set to cover, for example, about 95% or some other percentage of the historical changes in currency conversion rates over a typical authorization to clearing time interval. For example, the share may include 0.0068 USD/GB, whereby the resulting fixed currency conversion rate at authorization, in this example, for the transaction is 1.3618 USD/GBP. It should be appreciated that the share may be more or less in other embodiments. What's more, the share may be variable depending, for example, on the transaction amount, merchant category of the merchant 102 and/or ATM 112, a type of the transaction, the time of day or day of the week (e.g., the share may be larger for a transaction that occurs after a settlement cutoff or on the weekend, etc.), etc., whereby the share may be different for transactions having different MCCs or different transaction types despite other aspects of the transactions being the same. In one particular example, the share may be increased for a merchant that has clearing submissions conventionally longer than one or two days (e.g., hotel merchants, car rental agencies, etc.).

Next in the method 300, at 308, the fee manager 116 calculates a converted transaction amount for the transaction at the time of authorization (an authorization transaction amount) using the fixed authorization currency conversion rate, as, in this example, £100.00×1.3618 USD/GBP currency conversion rate, to provide an authorization transaction amount of $136.18. Thereafter, at 310, the fee manager 116 stores the fixed authorization currency conversion rate in the data structure 120 (and, in some embodiments, the converted transaction amount as well for later use). In so doing, the fee manager 116 may store the fixed authorization currency conversion rate in the data structure 120 in association with one or more aspects of the underlying transaction such as, for example, an authorization ID for the transaction, the original transaction amount, a date and time of the transaction and/or corresponding authorization request, an indication of the merchant 102, etc.

The authorization transaction amount is then passed to the issuer 108, at 312, by the fee manager 116 (as part of the authorization request (e.g., as appended thereto, etc.)). Upon receipt of the authorization request, the issuer 108 determines to approve or decline the transaction and compiles, at 318, an authorization reply therefor. The authorization reply is then transmitted, by the issuer 108, at 320, to the authorization network 106a of the payment network 106. In response, the authorization network 106a forwards, at 322, the authorization reply to the acquirer 104. And as is conventional, the acquirer 104 passes the authorization reply, at 323, back to the merchant 102, at which the transaction originated. In connection therewith, when the transaction is approved by the issuer 108, the acquirer 104 also appends the transaction to respective batch clearing files (for use in subsequently clearing and settling the transaction).

In connection with approving (or declining) the transaction, in this example, the issuer 108 also transmits, at 324, a notice of the authorization transaction amount to the user 110, at the communication device 114. For instance, the issuer 108 may transmit the notice message to the communication device 114 via an application installed thereon, via an SMS text message, or via an email, etc. In so doing, the notice message may include the authorization transaction amount and/or the determined currency conversion rate at the time of authorization for the transaction. Additionally, or alternatively, the issuer 108 may communicate such information to the user 110 in a more conventional manner, such as an entry to the user's account statement, etc.

Next in the method 300, clearing of the transaction (when approved by the issuer 108) may be performed at various intervals, including, for example, once per day, multiple times per day, or less than once per day (based on the batch clearing files generated by the acquirer 104 and/or the issuer 108). In particular in the method 300, and consistent with the clearing interval of the payment network 106, for example, the acquirer 104 forwards, at 326, a batch clearing file (including a clearing file or record for the given transaction, which includes various details of the transaction including, for example, the currency code for the merchant 102 (e.g., GBP, etc.), the currency code of the native currency of the user's payment account (e.g., U.S. Dollars, etc.)) to the payment network 106, and in particular, the clearing system 106b of the payment network 106. It should be appreciated that the acquirer 104 may forward the batch clearing file (including the clearing file or record for the given transaction) on the same day the transaction was authorized or on another day subsequent to initial transaction authorization (e.g., multiple days after the transaction authorization, etc.) depending on the type of transaction, the type of merchant 102 involved in the transaction, etc.

In turn, the clearing system 106b determines whether the transaction requires currency conversion, at 328. This may be accomplished, again, by comparing the currency code for the merchant 102 in the clearing file for the transaction to the currency code of the native currency of the user's payment account (e.g., GBP to U.S. Dollars, etc.), etc. When conversion is required, the clearing system 106b determines, at 330, the current currency conversion rate for the transaction, at the time of clearing, as is conventional (e.g., 1.3525 USD/GBP in the above example, etc.) (broadly, a final network conversion rate for the transaction). The clearing system 106b then converts the transaction amount as received in the merchant's currency (as determined from the clearing record for the transaction) to a final clearing transaction amount (in the native currency of the user's payment account) (e.g., £100.00×1.3525 USD/GBP=$135.25 in the above example (where the final amount of the transaction, in this example, remained £100.00); etc.). And, the clearing system 106b includes the final clearing transaction amount in the clearing record for the transaction, and directs, at 331, the clearing record to the issuer 108.

In connection with the above, since conversion is required for the transaction, the fee manager 118 intercepts the clearing record and requests, at 332, the fixed authorization currency conversion rate for the transaction from the data structure 120 (e.g., based on the authorization ID of the given clearing record in the batch file, the date and time of the transaction and/or corresponding authorization request, etc.). In response, the data structure 120 provides, at 333, the requested fixed authorization currency conversion rate for the transaction back to the fee manager 118. The fee manager 118 then determines the amount to bill the user 110 based on the fixed authorization currency conversion rate (as retrieved from the data structure 120) and the final transaction amount for the transaction as received in the merchant's currency in the clearing record (where, as described above, the final transaction amount for the transaction may or may not be the same as the transaction amount at authorization). And, the fee manager 118 replaces, at 334, the clearing transaction amount for the transaction in the clearing record (as calculated by the clearing system 106b) (e.g., in a data element representing the billing amount directed to the user 110, etc.) with the final transaction amount calculated by the fee manager 118, and then directs the clearing record, as modified, to the issuer 108, at 335.

Cardholder billing of the transaction then proceeds in a generally conventional manner (based on the final converted transaction amount determined by the fee manager 118 and appended to the clearing record), whereby in the above example the user 110 is billed $136.18 (at the fixed authorization currency conversion rate).

However, to address the difference in the fixed authorization currency conversion rate for the transaction and the currency conversion rate at clearing (and the difference in the amounts billed to the issuer 108 and the user 110), the fee manager 118 calculates, at 336, a difference between the rates. In the above example, the difference is 0.0093 USD/GBP (or 1.3618 USD/GBP−1.3525 USD/GBP), such that the issuer 108 receives $0.93 more from user 110 for the transaction (i.e., 0.0093 USD/GBP×£100.00), based on the fixed authorization currency conversion rate for the transaction, than it pays to the payment network 106 during settling of the transaction (i.e., the user 110 is billed $136.18 for the transaction (e.g., by the issuer 108, etc.) while the issuer 108 is billed $135.25 (e.g., by the payment network 106, etc.)). To address (or reconcile) this difference, the fee manager 118 generates a separate rectification transaction, at 338, in which the difference of $0.93 (or an amount less than $0.93, taking into account interchange and network fees) is billed to the issuer 108 (e.g., as a rectification transaction amount, etc.).

Alternatively in the above example, if the fee manager 118 determines the current currency conversion rate, at the time of clearing, to be 1.3650 USD/GBP, the fee manager 118 then calculates the clearing transaction amount to be $136.50 (i.e., £100.00×1.3650 USD/GBP), whereby the user 110 is billed $136.18 for the transaction (as the fixed authorization transaction amount) and the issuer 108 is billed $136.50 (as the clearing transaction amount). Here, the fee manager 118 calculates the difference between the fixed authorization currency conversion rate and the currency conversion rate at clearing to be −0.0032 USD/GBP (or 1.3618 USD/GBP−1.3650 USD/GBP), such that the issuer 108 receives $0.32 less from user 110 for the transaction (i.e., −0.0032 USD/GBP×£100.00), based on the fixed authorization currency conversion rate for the transaction, than it pays to the acquirer 104 during settling of the transaction. To address this difference, the fee manager 118 again generates a separate rectification transaction, in which the difference of $0.32 (or some amount less than $0.32, taking into account interchange and network fees (and assuming such fees are less than $0.32 in this example) is credited to the issuer 108.

With that said, and as generally described above, in various embodiments, two amounts are typically converted herein by the payment network 106: (a) the settlement amount from the merchant's currency into the issuer's settlement currency (net of interchange fees network fees, and account for the current conversion rate), and (b) the transaction amount from the merchant's currency into the cardholder's currency. In so doing, the first converted amount (i.e., the settlement amount) represents the cost of the transaction to the issuer. And, the second converted amount (the transaction amount) represents the offsetting revenue from the cardholder. In connection therewith, it should also be appreciated that the currencies used in the two conversions may be the same (e.g., the Egyptian bank may accept a transaction in Euros and settle (in (a)) with the payment network in Egyptian Pounds (EGP), and also bill (in (b)) its cardholder in EGP; etc.) or the currencies may be different (e.g., an Egyptian bank may accept a transaction in Euros and settle (in (a)) with the payment network in USD, but bill (in (b)) their cardholder in EGP; etc.). The systems and methods herein address both conversions, and thus address both scenarios where the currencies used in both conversions are the same (e.g., where the issuer settles in the same currency used to bill the cardholder (such as EGP), etc.) or are different (e.g., where the issuer settles in a different currency than used to bill the cardholder (e.g., the issuer may fix its settlement cost (based on a conversion of Euros to USD for settlement) and then use an internal conversion rate to convert from USD to EGP for cardholder billing, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, via a payment network, an authorization request message for a purchase transaction at a merchant requiring currency conversion in connection with authorization of the purchase transaction, the purchase transaction directed to a payment account and involving a transaction amount; (b) determining a fixed currency conversion rate for the purchase transaction; (c) determining an authorization transaction amount for the purchase transaction based on the transaction amount and the fixed currency conversion rate; (d) transmitting the authorization request message, including the authorization transaction amount, to an issuer associated with the payment account; (e) receiving, at a computing device, via the payment network, a clearing file for the purchase transaction from an acquirer associated with the merchant in connection with clearing of the purchase transaction; (f) identifying, by the computing device, a final currency conversion rate for the purchase transaction; (g) determining, by the computing device, a clearing transaction amount for the purchase transaction based on the transaction amount and the final currency conversion rate; (h) generating a rectification transaction, separate from the purchase transaction, for a difference between the authorization transaction amount for the purchase transaction and the clearing transaction amount for the purchase transaction; and (i) settling funds between the acquirer and the issuer for the purchase transaction consistent with the clearing transaction amount, and settling funds between the issuer and the payment network for the rectification transaction consistent with the difference between the authorization transaction amount for the purchase transaction and the clearing transaction amount for the purchase transaction.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, via a payment network, an authorization request message for a purchase transaction requiring currency conversion in connection with authorization of the purchase transaction, the purchase transaction directed to a payment account and involving a transaction amount; (b) determining a fixed currency conversion rate for the purchase transaction; (c) determining an authorization transaction amount for the purchase transaction based on the transaction amount and the fixed currency conversion rate; (d) transmitting the authorization request message, including the authorization transaction amount, to an issuer associated with the payment account; (e) receiving, at a computing device, via the payment network, a clearing file for the purchase transaction in connection with clearing of the purchase transaction, the clearing file including a clearing transaction amount for the purchase transaction based on a final transaction amount for the transaction and a clearing currency conversion rate; (f) determining, by the computing device, a billing transaction amount for the purchase transaction based on the final transaction amount for the transaction and the fixed currency conversion rate; (g) appending, by the computing device, the billing transaction amount to the clearing file, thereby enabling the issuer to bill a user associated with the payment account the billing transaction amount based on the fixed currency conversion rate instead of the clearing transaction amount based on the clearing currency conversion rate; and (h) generating a rectification transaction for a difference between the billing transaction amount for the purchase transaction and the clearing transaction amount for the purchase transaction.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing a fixed currency conversion rate for a transaction, the method comprising:
receiving, via a payment network, an authorization request message for a purchase transaction requiring currency conversion in connection with authorization of the purchase transaction, the purchase transaction directed to a payment account and involving a transaction amount;
determining a fixed currency conversion rate for the purchase transaction;
determining an authorization transaction amount for the purchase transaction based on the transaction amount and the fixed currency conversion rate;
transmitting the authorization request message, including the authorization transaction amount, to an issuer associated with the payment account;
receiving, at a computing device, via the payment network, a clearing file for the purchase transaction in connection with clearing of the purchase transaction, the clearing file including a clearing transaction amount for the purchase transaction based on a final transaction amount for the transaction and a clearing currency conversion rate;
determining, by the computing device, a billing transaction amount for the purchase transaction based on the final transaction amount for the transaction and the fixed currency conversion rate;
appending, by the computing device, the billing transaction amount to the clearing file, thereby enabling the issuer to bill a user associated with the payment account the billing transaction amount based on the fixed currency conversion rate instead of the clearing transaction amount based on the clearing currency conversion rate; and
generating a rectification transaction for a difference between the billing transaction amount for the purchase transaction and the clearing transaction amount for the purchase transaction.

2. The computer-implemented method of claim 1, wherein determining the fixed currency conversion rate includes identifying a current currency conversion rate for the purchase transaction based on a time and/or date associated with the purchase transaction and increasing the identified current currency conversion rate by a share, thereby providing the fixed currency conversion rate for the purchase transaction.

3. The computer-implemented method of claim 2, wherein the share includes a percentage based on a type of the purchase transaction and/or a category of a merchant or ATM involved in the purchase transaction.

4. The computer-implemented method of claim 2, wherein the share is fixed for the issuer of the payment account, regardless of a type of the purchase transaction.

5. The computer-implemented method of claim 1, wherein the clearing currency conversion rate includes a current currency conversion rate at a time and/or date associated with the clearing file; and
wherein the authorization transaction amount is the same as the final transaction amount.

6. The computer-implemented method of claim 1, further comprising storing the fixed currency conversion rate in a data structure; and
retrieving, by the computing device, the fixed currency conversion rate from the data structure prior to determining the billing transaction amount.

7. The computer-implemented method of claim 6, wherein retrieving the fixed currency conversion rate includes retrieving the fixed currency conversion rate based on an authorization ID of the purchase transaction.

8. The computer-implemented method of claim 1, wherein the rectification transaction includes a debit from an account associated with the issuer when the clearing transaction amount is greater than the billing transaction amount; and
wherein the rectification transaction includes a credit to the account associated with the issuer when the clearing transaction amount is less than the billing transaction amount.

9. The computer-implemented method of claim 1, further comprising adding a cross-border fee to the authorization transaction amount, prior to transmitting the authorization request message to the issuer associated with the payment account; and
adding the cross-border fee to the billing transaction amount, prior to appending the billing transaction amount to the clearing file.

10. The computer-implemented method of claim 1, further comprising appending the authorization transaction amount to the authorization request message prior to transmitting the authorization request message to the issuer associated with the payment account.

11. The computer-implemented method of claim 10, further comprising:
receiving, via the payment network, an authorization reply for the purchase transaction from the issuer associated with the payment account; and
transmitting the authorization reply to a merchant involved in the purchase transaction.

12. The computer-implemented method of claim 1, wherein generating the rectification transaction includes consolidating the difference between the billing transaction amount for the purchase transaction and the clearing transaction amount for the purchase transaction into a settlement transaction amount directed to the issuer.

13. The computer-implemented method of claim 12, further comprising settling funds between the issuer and the user for the purchase transaction consistent with the billing transaction amount, and settling funds with the issuer for the rectification transaction consistent with the difference between the billing transaction amount for the purchase transaction and the clearing transaction amount for the purchase transaction.

14. A system for use in providing a fixed currency conversion rate for a transaction, the system comprising:
a data structure configured to store fixed currency conversion rates for purchase transactions facilitated through a payment network, the fixed currency conversion rates determined for the purchase transactions in connection with authorization of the purchase transactions via the payment network; and
a fee manager computing device in communication with the data structure and the payment network, the fee manager computing device configured to:
receive, via the payment network, a clearing file for a purchase transaction by a user, from an acquirer involved in the purchase transaction, in connection with clearing of the purchase transaction, the purchase transaction directed to a payment account associated with the user, the clearing file including a clearing transaction amount for the purchase transaction based on a final transaction amount for the purchase transaction and a clearing currency conversion rate;
retrieve, from the data structure, a fixed currency conversion rate for the purchase transaction, as determined in connection with authorization of the purchase transaction, based on an authorization ID for the purchase transaction;
determine a billing transaction amount for the purchase transaction based on the final transaction amount for the transaction and the retrieved fixed currency conversion rate;
append the billing transaction amount to the clearing file, thereby enabling an issuer of the payment account to bill the user the billing transaction amount based on the fixed currency conversion rate instead of the clearing transaction amount based on the clearing currency conversion rate; and
determine a difference between the billing transaction amount for the purchase transaction and the clearing transaction amount for the purchase transaction and reconcile the difference with the issuer.

15. The system of claim 14, further comprising an authorization network computing device in communication with the data structure and the payment network, the authorization network computing device configured to:
receive, via the payment network, an authorization request for the purchase transaction from the acquirer;
determine the fixed currency conversion rate for the purchase transaction;
determine an authorization transaction amount for the purchase transaction based on the transaction amount and the fixed currency conversion rate; and
transmit the authorization request, including the authorization transaction amount, to the issuer associated with the user's payment account.

16. The system of claim 14, wherein the fee manager computing device is further configured to:
generate a rectification transaction, separate from the purchase transaction, for the difference between the billing transaction amount for the purchase transaction and the clearing transaction amount for the purchase transaction in connection with reconciling the difference with the issuer; and
settle funds for the rectification transaction, with the issuer, consistent with the difference between the billing transaction amount for the purchase transaction and the clearing transaction amount for the purchase transaction.

17. The system of claim 16, further comprising a clearing system computing device in communication with the data structure and the payment network, the clearing system computing device configured to:
determine that the purchase transaction requires currency conversion;
identify the clearing currency conversion rate for the purchase transaction, based on a time and/or date associated with clearing of the purchase transaction; and
determine the clearing transaction amount for the purchase transaction based on the final transaction amount for the purchase transaction and the identified currency conversion rate.

18. The system of claim 17, wherein the clearing system computing device is further configured to settle funds for the purchase transaction, between the payment network and the issuer of the payment account associated with the user, consistent with the clearing transaction amount.

19. The system of claim 18, wherein the payment network includes the fee manager computing device, the clearing system computing device, and the authorization network computing device.

20. A non-transitory computer-readable storage medium including executable instructions for providing a fixed currency conversion rate for a transaction, which, when executed by at least one processor, cause the at least one processor to:
receive, via a payment network, a clearing file for a purchase transaction by a user in connection with clearing of the purchase transaction, the purchase transaction directed to a payment account associated with the user, the clearing file including a clearing transaction amount for the purchase transaction based on a final transaction amount for the purchase transaction and a clearing currency conversion rate;
retrieve, from a data structure, a fixed currency conversion rate for the purchase transaction, as determined in connection with authorization of the purchase transaction, based on an authorization ID for the purchase transaction;
determine a billing transaction amount for the purchase transaction based on the final transaction amount for the transaction and the retrieved fixed currency conversion rate;
append the billing transaction amount to the clearing file, thereby enabling an issuer of the payment account to bill the user the billing transaction amount based on the fixed currency conversion rate instead of the clearing transaction amount based on the clearing currency conversion rate; and
determine a difference between the billing transaction amount for the purchase transaction and the clearing transaction amount for the purchase transaction and reconcile the difference with the issuer as part of settlement of funds for the purchase transaction.
